(19) United States
(12) Patent Application Publication
(10) Pub. No.: US 2025/0193800 A1
(43) Pub. Date: Jun. 12, 2025

(54) LONG-DISTANCE WI-FI COMMUNICATION METHOD AND APPARATUS THEREOF

(71) Applicant: MEDIATEK INC., Hsinchu City (TW)

(72) Inventors: Feng-Chi WU, Hsinchu City (TW); Chih-Kun CHANG, Hsinchu City (TW)

(21) Appl. No.: 18/535,382

(22) Filed: Dec. 11, 2023

(51) Int. Cl. H04W 52/02

(52) U.S. Cl. CPC H04W 52/0248; H04W 52/0235

(57) ABSTRACT

A long-distance Wi-Fi communication method is provided. The long-distance Wi-Fi communication method may include the following steps. An apparatus may connect with a network node at a contention access stage. The apparatus may receive the target wake time (TWT) configuration at the contention access stage from a network node, wherein the TWT configuration may comprise a TWT service period (SP) and a TWT interval associated with the apparatus. The apparatus may perform a communication with the network node during the TWT SP based on the TWT configuration at a contention-free stage.

### BACKGROUND OF THE INVENTION

### Field of the Invention

The invention generally relates to wireless communication technology, and more particularly, to a long-distance Wi-Fi communication technology with a target wake time (TWT) transmission mechanism.

### Description of the Related Art

As demand for ubiquitous computing and networking has grown, various wireless technologies have been developed, including Wireless-Fidelity (Wi-Fi) which is a Wireless Local Area Network (WLAN) technology allowing mobile devices (such as a smartphone, a smart pad, a laptop computer, a portable multimedia player, an embedded apparatus, or the like) to obtain wireless services in a frequency band of 2.4 GHz, 5 GHz, 6 Gz or 60 GHz.

The Institute of Electrical and Electronics Engineers (IEEE) has commercialized or developed various technological standards since the initial WLAN technology supported using frequencies of 2.4 GHz. For example, IEEE 802.11ac supports Multi-User (MU) transmission using spatial degrees of freedom via a MU-Multiple Input-Multiple-Output (MU-MIMO) scheme in a downlink (DL) direction from an Access Point (AP) to Stations (STAs). To improve performance and meet users' demand for high-capacity and high-rate services, IEEE 802.11ax has been proposed, which uses both Orthogonal Frequency Division Multiple Access (OFDMA) and MU-MIMO in both DL and uplink (UL) directions. That is, in addition to supporting frequency and spatial multiplexing from an AP to multiple STAs, transmissions from multiple STAs to the AP are also supported in IEEE 802.11ax.

In a long-distance (e.g., 30 KM) Wi-Fi communication, because the AP or the STA may use the directional antennas for the long-distance Wi-Fi communication, the AP or the STA may not detect another nearby device (i.e., hidden node) when Carrier Sense Multiple Access with Collision Avoidance (CSMA/CA) is used. Therefore, collision caused by the hidden node may occur. In addition, for the long-distance Wi-Fi communication, the propagation delay will be increased. Therefore, when the block acknowledgement (BA) waiting time is shorter than the propagation delay, the transmission error will be increased.

Therefore, how to perform the long-distance Wi-Fi communication efficiently is a topic that is worthy of discussion.

### BRIEF SUMMARY OF THE INVENTION

Long-distance Wi-Fi communication methods and an apparatus are provided to overcome the problems mentioned above.

An embodiment of the invention provides a long-distance Wi-Fi communication method. The long-distance Wi-Fi communication method may include the following steps. The apparatus may connect with a network node at a contention access stage. The apparatus may receive the target wake time (TWT) configuration at the contention access stage from a network node, wherein the TWT configuration may comprise a TWT service period (SP) and a TWT interval associated with the apparatus. The apparatus may perform a communication with the network node during the TWT SP based on the TWT configuration at a contention-free stage.

An embodiment of the invention provides a long-distance Wi-Fi communication method. The long-distance Wi-Fi communication method may include the following steps. The network node may connect with at least one station (STA) at a contention access stage. The network node may transmit at least one target wake time (TWT) configuration to the at least one STA at the contention access stage, wherein the TWT configuration comprises a TWT service period (SP) and a TWT interval associated with the STA. In addition, the network node may perform a communication with the at least one STA during the corresponding TWT SP based on the at least one TWT configuration at a contention-free stage.

An embodiment of the invention provides an apparatus for a long-distance Wi-Fi communication. The apparatus may include a transceiver and a processor. The transceiver is configured to perform wireless transmission and reception to and from a network node. The processor is coupled to the transceiver. The processor may be configured to connect with a network node at a contention access stage. The processor may be configured to receive the target wake time (TWT) configuration at the contention access stage from a network node, wherein the TWT configuration may comprise a TWT service period (SP) and a TWT interval associated with the apparatus. In addition, the processor may be configured to perform a communication with the network node during the TWT SP based on the TWT configuration at a contention-free stage.

Other aspects and features of the invention will become apparent to those with ordinary skill in the art upon review of the following descriptions of specific embodiments of the long-distance Wi-Fi communication methods and the apparatus.

### BRIEF DESCRIPTION OF THE DRAWINGS

The invention will become more fully understood by referring to the following detailed description with reference to the accompanying drawings, wherein:

FIG. 1 is a block diagram of a wireless communications system 100 according to an embodiment of the invention.

FIG. 2 is a block diagram of a communication apparatus 200 according to an embodiment of the invention.

FIG. 3 is a block diagram of a network apparatus 300 according to an embodiment of the invention.

FIG. 4 is a schematic diagram illustrating a contention access stage according to an embodiment of the invention.

FIG. 5 is a schematic diagram illustrating an initial process for a TWT SP in a long-distance Wi-Fi communication according to an embodiment of the invention.

FIG. 6 is a schematic diagram illustrating DL transmission during the TWT SP in a long-distance Wi-Fi communication according to another embodiment of the invention.

FIG. 7 is a schematic diagram illustrating UL transmission during the TWT SP in a long-distance Wi-Fi communication according to another embodiment of the invention.

FIG. 8 is a schematic diagram illustrating the overlap of two TWT SPs in a long-distance Wi-Fi communication according to another embodiment of the invention.

FIG. 9 is a flow chart illustrating a long-distance Wi-Fi communication method according to an embodiment of the invention.

FIG. 10 is a flow chart illustrating a long-distance Wi-Fi communication method according to another embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

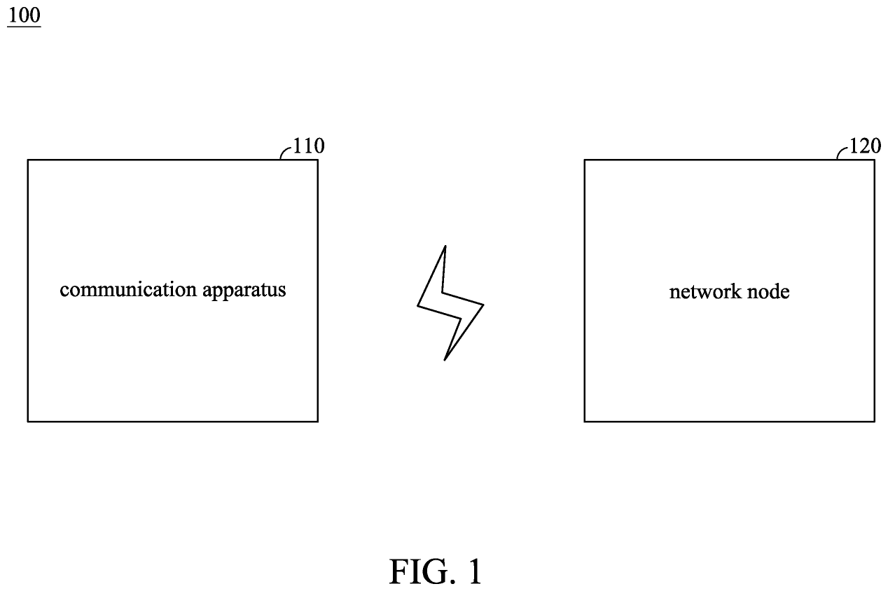

FIG. 1 is a block diagram of a wireless communications system 100 according to an embodiment of the invention. As shown in FIG. 1, the wireless communications system 100 may comprise communication apparatus 110 and a network node 120. The network node 120 may be an entity compatible with the Institute of Electrical and Electronics Engineers (IEEE) 802.11 standards to provide and manage the access to the wireless medium for the communication apparatus 110. It should be noted that, in order to clarify the concept of the invention, FIG. 1 presents a simplified block diagram in which only the elements relevant to the invention are shown. However, the invention should not be limited to what is shown in FIG. 1. For example, the wireless communications system 100 may comprise other communication apparatuses.

According to the embodiments of the invention, the communication apparatus 110 may communicate with network node 120 through a long-distance Wi-Fi communication, e.g., the distance between the communication apparatus 110 and the network node 120 may be longer than 30 km, but the invention should not be limited thereto.

In an embodiment of the invention, the communication apparatus 110 may be a non-AP station (STA), a repeater, a mobile phone (e.g., feature phone or smartphone), a panel Personal Computer (PC), a laptop computer, or any computing device, as long as it is compatible with the same IEEE 802.11 standards as the network node 120. The communication apparatus 110 may associate and communicate with the network node 120 to send or receive data in an uplink (UL) or downlink (DL) Multi-User-Physical layer Protocol Data Unit (MU-PPDU). The MU-PPDU may be a resource-unit Orthogonal Frequency Division Multiple Access (RU-OFDMA), a MU-Multiple Input-Multiple-Output (MU-MIMO) PPDU, or an aggregated PPDU.

In an embodiment of the invention, the network node 120 may be an Extremely High Throughput (EHT) AP which is compatible with the IEEE 802.11be in standards. In another embodiment of the invention, the network node 120 may be an AP which is compatible with any IEEE 802.11 standards later than 802.11be.

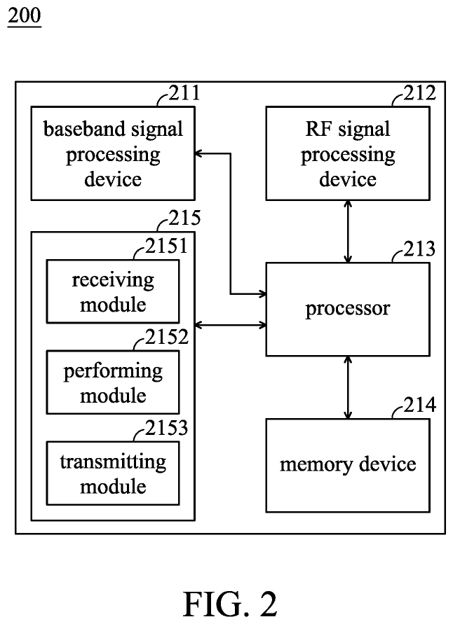

FIG. 2 is a block diagram of a communication apparatus 200 according to an embodiment of the invention. The communication apparatus 200 may be applied to communication apparatus 110. As shown in FIG. 2, the communication apparatus 200 may comprise at least a baseband signal processing device 211, a radio frequency (RF) signal processing device 212, a processor 213, a memory device 214, and function modules and circuits 215.

The RF signal processing device 212 may be a transceiver. The RF signal processing device 212 may comprise a plurality of antennas to receive or transmit RF signals. The RF signal processing device 212 may receive RF signals via the antennas and process the received RF signals to convert the received RF signals to baseband signals to be processed by the baseband signal processing device 211, or receive baseband signals from the baseband signal processing device 211 and convert the received baseband signals to RF signals to be transmitted to a peer communications apparatus. The RF signal processing device 212 may comprise a plurality of hardware elements to perform radio frequency conversion. For example, the RF signal processing device 212 may comprise a power amplifier, a mixer, analog-to-digital converter (ADC)/digital-to-analog converter (DAC), etc.

The baseband signal processing device 211 may further process the baseband signals to obtain information or data transmitted by the peer communications apparatus. The baseband signal processing device 211 may also comprise a plurality of hardware elements to perform baseband signal processing.

The processor 213 may control the operations of the baseband signal processing device 211, the RF signal processing device 212, the memory device 214 and the function modules and circuits 215. According to an embodiment of the invention, the processor 213 may also be arranged to execute the program codes of the software module(s) of the corresponding baseband signal processing device 211, the RF signal processing device 212 and the function modules and circuits 215. The program codes accompanied by specific data in a data structure may also be referred to as a processor logic unit or a stack instance when being executed. Therefore, the processor 213 may be regarded as being comprised of a plurality of processor logic units, each for executing one or more specific functions or tasks of the corresponding software modules.

The memory device 214 may store the software and firmware program codes, system data, user data, etc. of the communication apparatus 200. The memory device 214 may be a volatile memory such as a Random Access Memory (RAM); a non-volatile memory such as a flash memory or Read-Only Memory (ROM); a hard disk; or any combination thereof. The memory device 214 may stores a look-up table for adjusting the RS reception scheduling.

According to an embodiment of the invention, the RF signal processing device 212 and the baseband signal processing device 211 may collectively be regarded as a radio module capable of communicating with a wireless network to provide wireless communications services in compliance with a predetermined Radio Access Technology (RAT). Note that, in some embodiments of the invention, the communication apparatus 200 may be extended further to comprise more than one antenna and/or more than one radio module, and the invention should not be limited to what is shown in FIG. 2.

The function modules and circuits 215 may comprise a receiving module 2151, a performing module 2152 and a transmitting module 2153. The processor 213 may execute different modules or circuits in the function modules and circuits 215 to perform embodiments of the present invention. In the embodiment of the invention, the receiving module 2151 may receive the target wake time (TWT) configuration and data from the network node. The performing module 2152 may perform a waiting BA timeout setting adjustment. The transmitting module 2153 may transmit data or messages to respond to the network node.

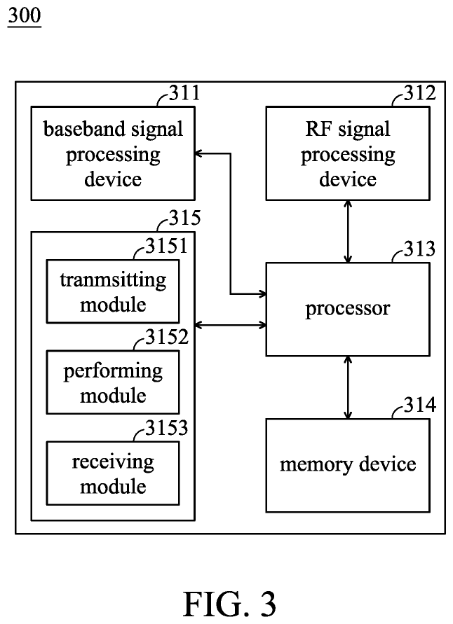

FIG. 3 is a block diagram of a network apparatus 300 according to an embodiment of the invention. The network apparatus 300 may be applied to the network node 120. As shown in FIG. 3, the network apparatus 300 may comprise at least a baseband signal processing device 311, a RF signal processing device 312, a processor 313, a memory device 314, and function modules and circuits 315.

The RF signal processing device 312 may be a transceiver. The RF signal processing device 312 may comprise a plurality of antennas to receive or transmit RF signals. The RF signal processing device 312 may receive RF signals via the antennas and process the received RF signals to convert the received RF signals to baseband signals to be processed by the baseband signal processing device 311, or receive baseband signals from the baseband signal processing device 311 and convert the received baseband signals to RF signals to be transmitted to a peer communications apparatus. The RF signal processing device 312 may comprise a plurality of hardware elements to perform radio frequency conversion. For example, the RF signal processing device 312 may comprise a power amplifier, a mixer, ADC/DAC, etc.

The baseband signal processing device 311 may further process the baseband signals to obtain information or data transmitted by the peer communications apparatus. The baseband signal processing device 311 may also comprise a plurality of hardware elements to perform baseband signal processing.

The processor 313 may control the operations of the baseband signal processing device 311, the RF signal processing device 312, the memory device 314 and the function modules and circuits 315. According to an embodiment of the invention, the processor 313 may also be arranged to execute the program codes of the software module(s) of the corresponding baseband signal processing device 311, the RF signal processing device 312 and the function modules and circuits 315. The program codes accompanied by specific data in a data structure may also be referred to as a processor logic unit or a stack instance when being executed. Therefore, the processor 313 may be regarded as being comprised of a plurality of processor logic units, each for executing one or more specific functions or tasks of the corresponding software modules.

The memory device 314 may store the software and firmware program codes, system data, user data, etc. of the network node apparatus 300. The memory device 314 may be a volatile memory such as a RAM; a non-volatile memory such as a flash memory or ROM; a hard disk; or any combination thereof. The memory device 314 may stores a look-up table for adjusting the RS reception scheduling.

According to an embodiment of the invention, the RF signal processing device 312 and the baseband signal processing device 311 may collectively be regarded as a radio module capable of communicating with a wireless network to provide wireless communications services in compliance with a predetermined Radio Access Technology (RAT). Note that, in some embodiments of the invention, the network apparatus 300 may be extended further to comprise more than one antenna and/or more than one radio module, and the invention should not be limited to what is shown in FIG. 3.

The function modules and circuits 315 may comprise a transmitting module 3151, a performing module 3152 and a receiving module 3153. The processor 313 may execute different modules or circuits in the function modules and circuits 315 to perform embodiments of the present invention. In the embodiment of the invention, the transmitting module 3151 may transmit a TWT configuration and data from the network node. The performing module 3152 may perform a waiting BA timeout setting adjustment. The receiving module 3153 may receive data or messages to respond to the network node.

According to the embodiments of the invention, when the communication apparatus 110 communicates with the network node 120 through a long-distance Wi-Fi communication, the communication apparatus 110 may receive a TWT configuration from a network node for a time division multiple access (TDMA) transmission. Then, the communication apparatus 110 may receive data frame or management frame from the network node 120 during the TWT service period (SP) or transmit data frame or management frame to the network node 120 during the TWT SP.

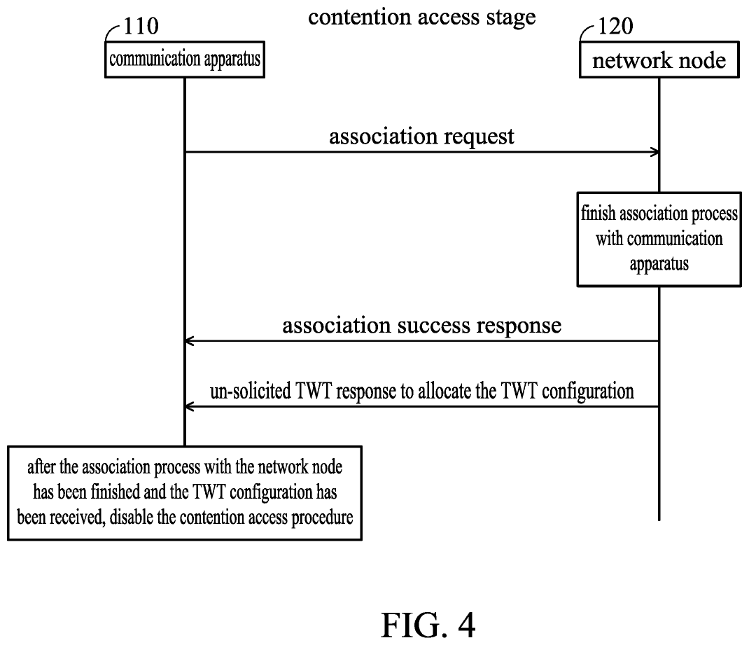

According to the embodiments of the invention, the TWT configuration may comprises a initial TWT indication, TWT service period (SP) and TWT interval, wherein TWT interval may indicate an interval between a start time of two consecutive TWT service period (SP), e.g. an interval between two consecutive wakeup times, the initial TWT indication may be used for obtaining an start time of an initial TWT service period (SP), e.g. an initial wake time, and the TWT service period (SP) may be a period for communicating with the network node 120 during the contention-free stage. Specifically, the network node 120 may allocate or configure different TWT SPs in the TWT configuration to different communication apparatuses for performing the TDMA transmission with the different communication apparatuses. Each communication apparatus may start to monitor a channel to receive a frame (e.g., a trigger frame in FIG. 4) from network node based on the TWT interval and perform uplink (UL) transmission and downlink (DL) reception with the network node 120 during its configured TWT SP in the long-distance Wi-Fi communication. In one embodiment, the communication apparatus 110 may wake up at the initial wake time, and communicate with the network node 120 during its TWT SP. When the communication is completed in this TWT SP or this TWT SP is expired, the communication apparatus 110 may return to sleep mode. Then, the communication apparatus 110 may wake up every TWT interval to communicate with the network node 120, and when the communication is completed or the TWT SP is expired, the communication apparatus 110 may return to sleep mode. In another embodiment, communication apparatus 110 may not enter sleep mode. The communication apparatus 110 may communicate with the network node 120 during the TWT SP, when the communication is completed or the TWT SP is expired, the communication apparatus 110 may perform other operations without entering sleep mode. Then, the communication apparatus 110 may communicate with the network node 120 during next TWT SP based on the TWT interval.

According to an embodiment of the invention, the TWT configuration may be transmitted by the network node 120 based on a request from the communication apparatus 110. According to another embodiment of the invention, the TWT configuration may be transmitted by the network node 120 through an un-solicited response, i.e., the network node 120 may transmit the TWT configuration to the communication apparatus 110 without the request from the communication apparatus 110.

According to an embodiment of the invention, the communication apparatus 110 may receive the TWT configuration from the network node 120 at a contention access stage and perform the data transmission based on the TWT configuration (i.e., TDMA transmission realized by the TWT transmission mechanism) at a contention-free stage. FIG. 4 is a schematic diagram illustrating a contention access stage. Specifically, as shown in FIG. 4, at the contention access stage, the communication apparatus 110 may use the Carrier Sense Multiple Access with Collision Avoidance (CSMA/CA) after a beacon reception to check if the medium is free. When the medium is free, the communication apparatus 110 may send an association request to the network node 120 by using the medium. When the network node 120 receives the association request from the communication apparatus 110, the network node 120 may perform the association process with the communication apparatus 110. After the association process with the communication apparatus 110 has been finished, the network node 120 may transmit an association success response to the communication apparatus 110. In addition, the network node 120 may transmit an un-solicited TWT response to the communication apparatus 110 to allocate the TWT configuration for the communication apparatus 110. Alternatively, the un-solicited TWT response can be carried in the association success response. After the association process with the network node 120 has been finished and the TWT configuration has been received, the communication apparatus 110 may disable the contention access procedure. In addition, at the contention access stage, the network node 120 may not transmit or receive data traffic to or from the communication apparatus 110 to reduce the collision. At the contention-free stage, the communication apparatus 110 may perform the contention-free access (i.e., TDMA transmission realized by the TWT transmission mechanism) with the network node 120, and disable the contention access procedure (e.g., CSMA/CA process). For example, after the association process with the network node 120 has been finished and the TWT configuration has been received, the communication apparatus 110 may set the multi-user enhanced distributed channel access (MU EDCA) timer to a specific value to disable the CSMA/CA process, i.e., before the timer has been expired, the contention access procedure will not be performed, for example, set the MU EDCA timer to a very large value.

In an embodiment, the network node 120 may be regarded as a DL data/UL data scheduler. Taking FIG. 4 as an example, the network node 120 may allocate a plurality of TWT configurations for a plurality of communication apparatus (e.g., a plurality of STAs) during the contention access stage. Each communication apparatus may transmit or receive data during its TWT SP based on its corresponding TWT configuration during the contention-free stage. The TWT SP of each communication apparatus may overlap or does not overlap with another TWT SP corresponding to another communication apparatus. Accordingly, TDMA communication will be realized in the contention-free stage.

According to an embodiment of the invention, in contention-free stage, an initial process for the TWT SP is performed firstly, followed by the transmission of uplink and/or downlink data or management frame.

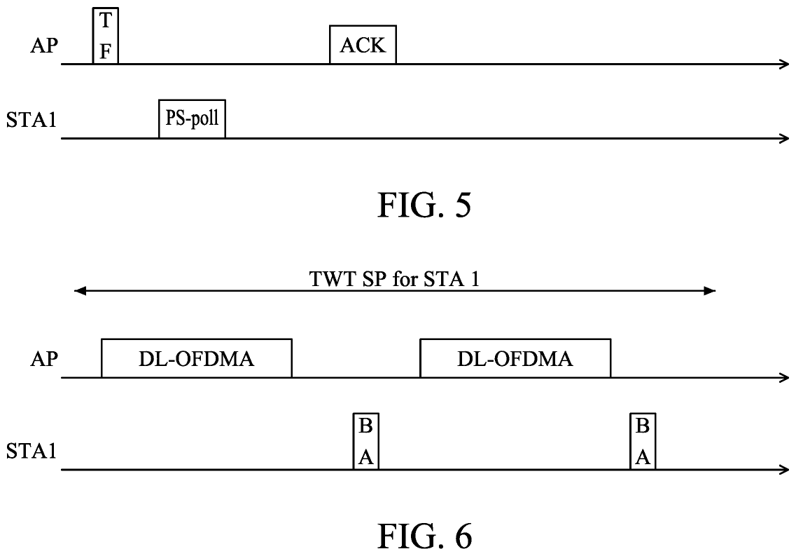

According to an embodiment of the invention, in an initial process for the TWT SP associated with the communication apparatus 110, the network node 120 may transmit a trigger frame (TF) to the communication apparatus 110 at the beginning of the TWT SP associated with the communication apparatus 110. Then, the communication apparatus 110 may transmit a power saving (PS)-poll frame for responding to the trigger frame to the network node 120 to indicate that the start of handshake of the TWT SP. Then, the network node 120 may transmit an acknowledgement (ACK) frame for responding to the PS-poll frame to the communication apparatus 110 to finish the handshake. That is, when the handshake has been finished, the communication apparatus 110 and the network node 120 will be able to transmit or receive data during the TWT SP associated with the communication apparatus 110. FIG. 5 is taken as an example for illustrating the embodiment below.

FIG. 5 is a schematic diagram illustrating an initial process in a long-distance Wi-Fi communication according to an embodiment of the invention. As shown in FIG. 5, the AP (e.g., network node 120) may transmit a TF to the STA 1 (e.g., communication apparatus 110) at the beginning of the TWT SP associated with the STA 1. Then, the STA 1 may transmit a PS-poll frame to the AP for responding to the TF. Then, the AP may transmit an ACK frame to the STA 1 for responding to the PS-poll frame.

FIG. 6 is a schematic diagram illustrating DL traffic transmission during the TWT SP in a long-distance Wi-Fi communication according to another embodiment of the invention. As shown in FIG. 6, the AP (act as network node 120) may transmit a downlink (DL)-Orthogonal Frequency-Division Multiple Access (OFDMA) frame to the STA 1 (act as communication apparatus 110) during the TWT SP associated with the STA 1. When the STA 1 receives the DL-OFDMA frame, the STA 1 may transmit a block ACK (BA) frame for responding to the DL-OFDMA frame to the AP during the TWT SP associated with the STA 1, wherein DL OFDMA frame may be a data frame or a management frame.

The process in FIG. 6 can follow the process in FIG. 5. Alternatively, during the TWT SP period, the process in FIG. 6 can be executed directly without executing the process in FIG. 5.

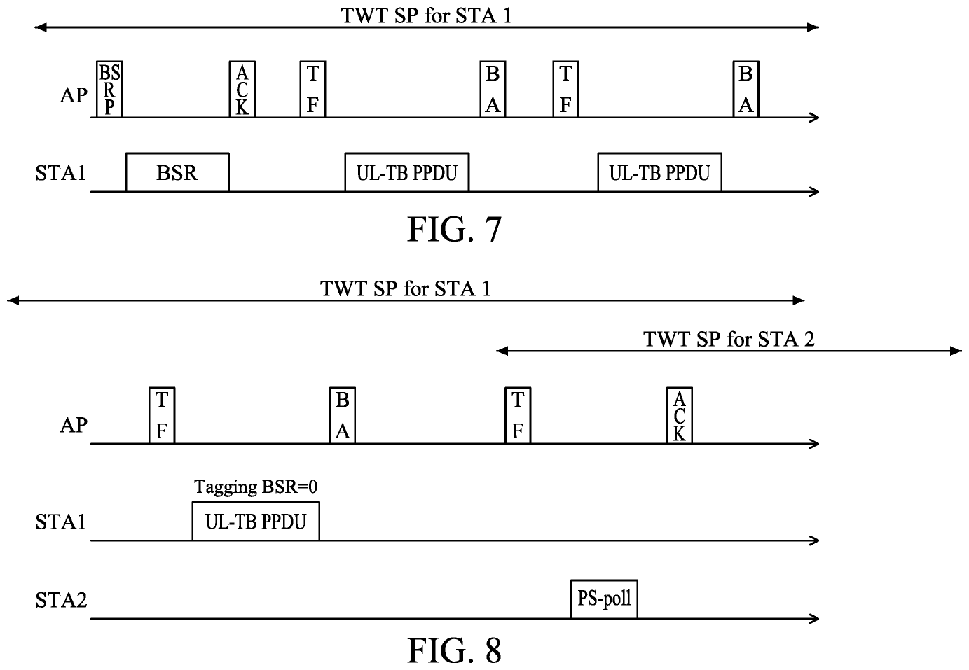

FIG. 7 is a schematic diagram illustrating for the UL traffic transmission during the TWT SP in a long-distance Wi-Fi communication according to another embodiment of the invention. As shown in FIG. 7, the AP (act as network node 120) may transmit a buffer state report poll (BSRP) frame to the STA 1 (act as communication apparatus 110) during the TWT SP associated with the STA 1 to ask a buffer state report before starting UL traffic transmission. Then, the STA 1 may transmit a buffer state report (BSR) for responding to the BSRP frame to the AP during the TWT SP associated with the STA 1. Then, the AP may transmit an ACK frame for responding to the BSR to the STA 1 during the TWT SP associated with the STA 1, i.e., the UL traffic transmission can be started. In addition, the AP may transmit a trigger frame (TF) to the STA 1 during the TWT SP associated with the STA 1. Then, the STA 1 may transmit an uplink (UL) trigger-based (TB) packet protocol data unit (PDDU) for responding to the TF to the AP during the TWT SP associated with the STA 1. Then, the AP may transmit a BA frame for responding to the UL-TB PPDU to the STA 1 during the TWT SP associated with the STA 1. In the embodiment, AP may send Trigger frame to solicit STA1 to send UL traffic until the TWT SP is expired or the tagging BSR is empty.

The process in FIG. 7 can follow the process in FIG. 6. Alternatively, during the TWT SP period, the process in FIG. 7 can be executed directly after the process in FIG. 5 without executing the process in FIG. 6. For example, there is no DL traffic transmission during this TWT SP. Alternatively, during the TWT SP period, the process in FIG. 7 can be executed directly without executing the process in FIG. 5 and the process in FIG. 6.

According to an embodiment of the invention, one station's TWT SP can overlap with another station's TWT SP.

FIG. 8 is a schematic diagram illustrating a long-distance Wi-Fi communication according to another embodiment of the invention. According to an embodiment of the invention, when the transmission between the communication apparatus 110 and the network node 120 is completed early (e.g., the BSR from the communication apparatus 110 is empty, i.e., tagging BSR=0) during the TWT SP associated with the communication apparatus 110, the network node 120 may perform an initial process for another TWT SP associated with another communication apparatus. Tagging BSR=0 may mean that no data has needed to be transmitted from the communication apparatus 110 to the network node 120, and therefore, the network node 120 may know the transmission between the communication apparatus 110 and the network node 120 is completed. In this case, the TWT SP associated with the communication apparatus 110 may be overlapped with another TWT SP associated with another communication apparatus to increase efficiency of the resource utilization.

As shown in FIG. 8, when the UL-TB PPDU from the STA 1 (e.g., communication apparatus 110) indicates that the tagging BSR=0, the AP (e.g., network node 120) may know that the transmission between the STA 1 and the AP is completed early during the TWT SP associated with the STA 1. Therefore, the AP may perform an initial process for TWT SP associated with the STA 2 (e.g., another communication apparatus) during the TWT SP associated with the STA 2.

According to an embodiment of the invention, the communication apparatus 110 and the network node 120 may set a BA waiting timeout. Specifically, the communication apparatus 110 and the network node 120 may increase the BA waiting timeout to make the increased BA waiting timeout (e.g., 256 μs, but the invention should be limited thereto) in the long-distance Wi-Fi communication is longer than the default BA waiting timeout (e.g., the default timeout of the communication apparatus 110 and the network node 120 waiting for the BA frame in an indoor Wi-Fi communication). Furthermore, the communication apparatus 110 and the network node 120 may set an ACK waiting timeout. Specifically, the communication apparatus 110 and the network node 120 may increase the ACK waiting timeout to make the increased ACK waiting timeout is longer than the default ACK waiting timeout. (e.g., the default timeout of the communication apparatus 110 and the network node 120 waiting for the ACK frame in an indoor Wi-Fi communication). Therefore, the issue occurred when the propagation delay is longer than the default BA waiting timeout or the default ACK waiting timeout in the long-distance Wi-Fi communication will can be avoided.

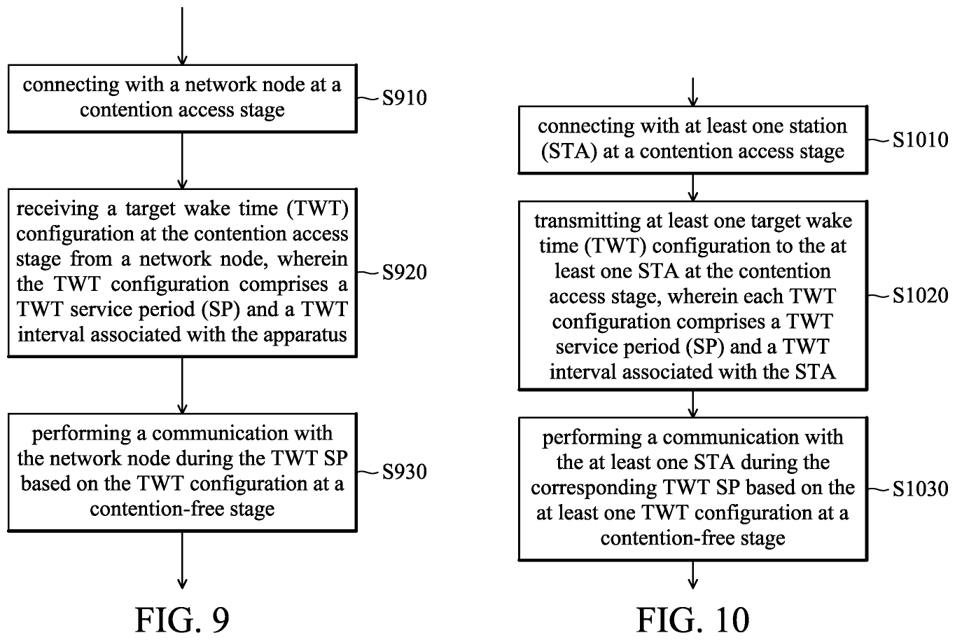

FIG. 9 is a flow chart illustrating a long-distance Wi-Fi communication method according to an embodiment of the invention. The long-distance Wi-Fi communication method can be applied to the communication apparatus 110 of the wireless communication system 100.

As shown in FIG. 9, in step S910, the communication apparatus 110 may connect with a network node at a contention access stage. The communication apparatus 110 may connect with a network node by using a contention access procedure. In this step 910, the communication apparatus 110 may finish an association process with the network node.

In step S920, the communication apparatus 110 may receive the target wake time (TWT) configuration at a contention access stage from the network node, wherein the TWT configuration indicates a TWT service period (SP) and a TWT interval associated with the communication apparatus 110.

In step S930, the communication apparatus 110 may perform a communication with the network node during the TWT SP at a contention-free stage.

According to an embodiment of the invention, the TWT configuration may comprises an initial TWT indication, TWT SP and TWT interval, wherein TWT interval may indicate an interval between a start time of two consecutive TWT SP, the initial TWT indication may be used for obtaining a start time of an initial TWT SP, and the TWT SP may be a period for communicating with the network node during the contention-free stage. The communication apparatus 110 may perform a communication with the network node during the TWT SP at a contention-free stage. During the non-TWT SP time, the communication apparatus 110 may enter a sleep mode or not enter a sleep mode.

According to an embodiment of the invention, in the long-distance Wi-Fi communication method, step S930 may comprise that the communication apparatus 110 receive or transmit a data frame or a management frame from or to the network node to realize a TDMA communication with the network node.

According to an embodiment of the invention, in the long-distance Wi-Fi communication method, the communication apparatus 110 may not transmit or receive the data to or from the network node at the contention access stage.

According to an embodiment of the invention, the TWT configuration is transmitted by the network node through an un-solicited response at the contention access stage.

According to an embodiment of the invention, in the long-distance Wi-Fi communication method, the communication apparatus 110 may further receive a trigger frame from the network node at the beginning of the TWT SP. Then, the communication apparatus 110 may further transmit a power saving (PS)-poll frame to the network node to indicate that a start of handshake of the TWT SP. In addition, the communication apparatus 110 may further receive acknowledgement (ACK) frame for the PS-poll frame from the network node during the TWT SP.

According to an embodiment of the invention, in the long-distance Wi-Fi communication method, the communication apparatus 110 may further receive a downlink (DL) data frame from the network node during the TWT SP. In addition, the communication apparatus 110 may further transmit a block acknowledgement (BA) frame for the DL data frame to the network node during the TWT SP.

According to an embodiment of the invention, in the long-distance Wi-Fi communication method, the communication apparatus 110 may further receive a buffer state report poll (BSRP) frame from the network node during the TWT SP. Then, the communication apparatus 110 may further transmit a buffer state report (BSR) in response to the BSRP to the network node during the TWT SP. Then, the communication apparatus 110 may further receive an ACK frame for the BSR from the network node during the TWT SP. In addition, the communication apparatus 110 may further receive a trigger frame from the network node during the TWT SP. Then, the communication apparatus 110 may further transmit an uplink (UL) trigger-based (TB) packet protocol data unit (PDDU) for the trigger frame to the network node during the TWT SP.

According to an embodiment of the invention, in the long-distance Wi-Fi communication method, the TWT SP associated with the communication apparatus 110 may be overlapped with another TWT SP associated with another apparatus.

According to an embodiment of the invention, in the long-distance Wi-Fi communication method, the communication apparatus 110 may further set a BA waiting timeout or an ACK waiting timeout, wherein the BA waiting timeout or the ACK waiting timeout is longer than the default BA waiting timeout or the default ACK waiting timeout.

According to an embodiment of the invention, in the long-distance Wi-Fi communication method, the communication apparatus 110 may set a timer to a specific value to disable the contention access procedure after receiving the TWT configuration.

FIG. 10 is a flow chart illustrating a long-distance Wi-Fi communication method according to another embodiment of the invention. The long-distance Wi-Fi communication method can be applied to the network node 120 of the wireless communication system 100. As shown in FIG. 10, in step S1010, the network node 120 may connect with at least one station (STA) at a contention access stage.

in step S1020, the network node 120 may transmit at least one target wake time (TWT) configuration to the at least one STA at the contention access stage, wherein each TWT configuration may comprise a TWT service period (SP) and a TWT interval associated with the STA.

In step S1030, the network node 120 may perform a communication with the at least one STA during the corresponding TWT SP based on the at least one TWT configuration at a contention-free stage.

According to an embodiment of the invention, in the long-distance Wi-Fi communication method, step S1030 may comprise that the network node 120 may transmit or receive a data frame or a management frame to or from the at least one STA.

According to an embodiment of the invention, in the long-distance Wi-Fi communication method, the network node 120 may not transmit the data or receive the data to or from any STA at the contention access stage.

According to an embodiment of the invention, the TWT configuration is transmitted by the network node 120 through an un-solicited response at the contention access stage.

According to an embodiment of the invention, in the long-distance Wi-Fi communication method, the network node 120 may further transmit a trigger frame to a first STA of the at least one STA at the beginning of a first TWT SP corresponding to the first STA. Then, the network node 120 may further receive a power saving (PS)-poll frame for the trigger frame from the first STA to know a start of handshake of the first TWT SP. In addition, the network node 120 may further transmit an acknowledgement (ACK) frame for the PS-poll frame to the first STA during the first TWT SP.

According to an embodiment of the invention, in the long-distance Wi-Fi communication method, the network node 120 may further transmit a downlink (DL) data frame to the first STA during the first TWT SP. In addition, the network node 120 may further receive a block acknowledgement (BA) frame for the DL data frame from the first STA during the first TWT SP.

According to an embodiment of the invention, in the long-distance Wi-Fi communication method, the network node 120 may further transmit a buffer state report poll (BSRP) frame to the first STA during the first TWT SP. Then, the network node 120 may further receive a buffer state report (BSR) in response to the BSRP from the first STA during the TWT SP. Then, the network node 120 may further transmit an ACK frame for the BSR to the first STA during the first TWT SP. In addition, the network node 120 may further transmit a trigger frame to the first STA during the first TWT SP. Then, the network node 120 may further receive an uplink (UL) trigger-based (TB) packet protocol data unit (PDDU) from the first STA during the first TWT SP.

According to an embodiment of the invention, in the long-distance Wi-Fi communication method, the first TWT SP associated with the first STA overlaps a second TWT SP associated with a second STA of the at least one STA. That is, when the communication between the first STA and the network node is completed before the first TWT SP ends, the network node 120 may further transmit a trigger frame to the second STA at the beginning of the second TWT SP or during the second TWT SP. Then, the network node 120 may further receive a PS-poll frame for the trigger frame from the second STA to know a start of handshake of the second TWT SP. In addition, the network node 120 may further transmit an acknowledgement (ACK) frame for the PS-poll frame to the second STA during the second TWT SP.

According to an embodiment of the invention, in the long-distance Wi-Fi communication method, the network node 120 may further set a BA waiting timeout or an ACK waiting timeout, wherein the BA waiting timeout or the ACK waiting timeout is longer than the default BA waiting timeout or the default ACK waiting timeout.

In the long-distance Wi-Fi communication methods provided in the invention, for long-distance Wi-Fi communication, the communication apparatus and the network node may adopt TWT transmission mechanism in the TDMA transmission. Therefore, the collision issues caused by hidden node can be avoided. In addition, in the long-distance Wi-Fi communication methods provided in the invention, the communication apparatus and the network node may enlarge the BA or ACK waiting timeout. Therefore, the issue occurred when the propagation delay is longer than the default BA or ACK waiting timeout in the long-distance Wi-Fi communication will can be avoided.

Use of ordinal terms such as “first”, “second”, “third”, etc., in the disclosure and claims is for description. It does not by itself connote any order or relationship.

It should be noted that although not explicitly specified, one or more steps of the methods described herein can include a step for storing, displaying and/or outputting as required for a particular application. In other words, any data, records, fields, and/or intermediate results discussed in the methods can be stored, displayed, and/or output to another device as required for a particular application. While the foregoing is directed to embodiments of the present invention, other and further embodiments of the invention can be devised without departing from the basic scope thereof. Various embodiments presented herein, or portions thereof, can be combined to create further embodiments. The above description is of the best-contemplated mode of carrying out the invention. This description is made for the purpose of illustrating the general principles of the invention and should not be taken in a limiting sense. The scope of the invention is best determined by reference to the appended claims.

The above paragraphs describe many aspects. Obviously, the teaching of the invention can be accomplished by many methods, and any specific configurations or functions in the disclosed embodiments only present a representative condition. Those who are skilled in this technology will understand that all of the disclosed aspects in the invention can be applied independently or be incorporated.

While the invention has been described by way of example and in terms of preferred embodiment, it should be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A long-distance Wi-Fi communication method, which is performed by an apparatus, comprising:
connecting with a network node at a contention access stage;
receiving a target wake time (TWT) configuration at the contention access stage from a network node, wherein the TWT configuration comprises a TWT service period (SP) and a TWT interval associated with the apparatus; and
performing a communication with the network node during the TWT SP based on the TWT configuration at a contention-free stage.

2. The long-distance Wi-Fi communication method of claim 1, wherein the step of performing the communication with the network node comprises receiving or transmitting a data frame or a management frame from or to the network node.

3. The long-distance Wi-Fi communication method of claim 1, further comprising:
not receiving or transmitting data from or to the network node at the contention access stage.

4. The long-distance Wi-Fi communication method of claim 1, wherein the TWT configuration is transmitted by the network node through an un-solicited response at the contention access stage.

5. The long-distance Wi-Fi communication method of claim 1, further comprising:
receiving a trigger frame from the network node at a beginning of the TWT SP;
transmitting a power saving (PS)-poll frame to the network node to indicate the start of handshake of the TWT SP; and
receiving an acknowledgement (ACK) frame for the PS-poll frame from the network node during the TWT SP.

6. The long-distance Wi-Fi communication method of claim 1, the step of performing the communication with the network node further comprising:
receiving a downlink (DL) data frame from the network node during the TWT SP; and
transmitting a block acknowledgement (BA) frame for the DL data frame to the network node during the TWT SP.

7. The long-distance Wi-Fi communication method of claim 1, the step of performing the communication with the network node further comprising:
receiving a buffer state report poll (BSRP) frame from the network node during the TWT SP;
transmitting a buffer state report (BSR) in response to the BSRP to the network node during the TWT SP;
receiving a BA frame for the BSR from the network node during the TWT SP;
receiving a trigger frame from the network node during the TWT SP; and
transmitting an uplink (UL) trigger-based (TB) packet protocol data unit (PDDU) to the network node during the TWT SP.

8. The long-distance Wi-Fi communication method of claim 1, wherein the TWT SP associated with the apparatus overlaps with another TWT SP associated with another apparatus.

9. The long-distance Wi-Fi communication method of claim 1, further comprising:
setting a BA waiting timeout or an ACK waiting timeout in the long-distance Wi-Fi communication, wherein the BA waiting timeout or the ACK waiting timeout in the long-distance Wi-Fi communication is longer than a default BA waiting timeout or a default ACK waiting timeout.

10. The long-distance Wi-Fi communication method of claim 1, further comprising:
setting a timer to a specific value to disable the contention access procedure after receiving the TWT configuration.

11. A long-distance Wi-Fi communication method, which is performed by a network node, comprising:
connecting with at least one station (STA) at a contention access stage;
transmitting at least one target wake time (TWT) configuration to the at least one STA at the contention access stage, wherein each TWT configuration comprises a TWT service period (SP) and a TWT interval associated with the STA; and
performing a communication with the at least one STA during the corresponding TWT SP based on the at least one TWT configuration at a contention-free stage.

12. The long-distance Wi-Fi communication method of claim 11, wherein the step of performing the communication with the at least one STA comprises transmitting or receiving a data frame or a management frame to or from the at least one STA to realize a time division multiple access (TDMA) communication.

13. The long-distance Wi-Fi communication method of claim 11, further comprising:
not transmitting or receiving data to or from any STA at the contention access stage.

14. The long-distance Wi-Fi communication method of claim 11, wherein the TWT configuration is transmitted by the network node through an un-solicited response.

15. The long-distance Wi-Fi communication method of claim 11, wherein the at least one STA comprises a first STA and a second STA, the first TWT SP associated with the first STA overlaps with a second TWT SP associated with a second STA, wherein the second TWT SP is configured by the network node.

16. The long-distance Wi-Fi communication method of claim 15, when the communication between the first STA and the network node is completed before the first TWT SP ends, the method further comprises:
transmitting a trigger frame to the second STA at a beginning of the second TWT SP;
receiving a PS-Poll frame for indicating a start of handshake of the second TWT SP from the second STA during the second TWT SP; and
transmitting an acknowledgement (ACK) frame for the PS-poll frame to the second STA during the second TWT SP.

17. The long-distance Wi-Fi communication method of claim 11, further comprising:
setting a block ACK (BA) waiting timeout or an ACK waiting timeout in the long-distance Wi-Fi communication, wherein the BA waiting timeout or the ACK waiting timeout in the long-distance Wi-Fi communication is longer than a default BA waiting timeout or a default ACK waiting timeout.

18. An apparatus for a long-distance Wi-Fi communication, comprising:
a transceiver, configured to perform wireless transmission and reception to and from a network node; and
a processor, coupled to the transceiver, and configured to:
connect, via the transceiver, with a network node at a contention access stage;
receive, via the transceiver, a target wake time (TWT) configuration at the contention access stage from a network node, wherein the TWT configuration comprises a TWT service period (SP) and a TWT interval associated with the apparatus; and;
perform a communication with the network node during the TWT SP based on the TWT configuration at a contention-free stage.

19. The apparatus of claim 18, wherein the TWT configuration is transmitted by the network node through an un-solicited response.

20. The apparatus of claim 18, further comprising:
not receiving or transmitting data from or to the network node at the contention access stage.
